(19) United States
(12) Patent Application Publication
(10) Pub. No.: US 2016/0048923 A1
(43) Pub. Date: Feb. 18, 2016

(54) METHOD AND SYSTEM FOR ESTIMATING ECONOMIC LOSSES FROM HAIL STORMS

(71) Applicant: SWYFFT, LLC, Park City, UT (US)

(72) Inventors: Sean MAHER, Park City, UT (US); Richard Trezza, Mendham, NJ (US)

(21) Appl. No.: 14/461,079

(22) Filed: Aug. 15, 2014

(51) Int. Cl. G06Q 40/08

(52) U.S. Cl. CPC G06Q 40/08

(57) ABSTRACT

The present invention relates to systems and methods for estimating economic losses from hail storms. Accordingly, provided herein are methods for insurance underwriting of hail risk. Also provided are systems and computer-readable storage media configured for performing the disclosed methods.

### BACKGROUND OF THE INVENTION

1. Field of the Invention

The invention generally relates to systems and methods for insurance underwriting, and in particular, to systems and methods that integrate information from multiple online databases to assess the risk of damage and economic loss from hail storms.

2. Background Information

Underwriting is the process an insurance company uses to determine whether or not a potential property is eligible for insurance, and to determine what premium the owner of that property should pay for insurance if eligible. The purpose of insurance underwriting is to spread risk among a pool of people or organizations in a manner that is both fair to the customer and profitable for the insurer. In order to be profitable, it does not make sense for insurance companies to insure all applicants. Although they do not want to make customers pay an excessively high rate, it is not wise for them to charge all customers the same premium. Underwriting therefore enables the company to determine the insurability of certain properties and to charge premiums that are commensurate with the level of risk associated with a particular property.

Risk classification of a particular property determines to a significant degree the premium a customer will pay for insurance. Four typical risk groups are: standard, preferred, substandard, and uninsurable. Each of these is explained below.

Standard risks: These are properties that, according to the insurance company's underwriting standards, are entitled to insurance without having to pay a rating surcharge or be subjected to policy restrictions.

Preferred risks: This group includes properties whose losses are expected to be below average and to whom the company offers a lower than standard rate.

Substandard risks: These are properties that, because of their location and/or the physical characteristics of the building, are expected to have higher than average losses. Substandard properties are insurable, but only at higher than standard rates commensurate with the added risk. Policies issued to substandard properties are referred to as “rated” or “extra risk” policies.

Uninsurable: These are properties to whom the company refuses to sell insurance because they are unwilling to shoulder the risks. In other words, the company has decided that the risk factors associated with the property are too great and/or too numerous for coverage. In certain cases, the company may determine that a property is uninsurable based on the property's characteristics being so rare or unique that the company has no basis to arrive at a suitable premium.

An insurance company typically looks at a number of factors during the underwriting process in order to evaluate a property in terms of risk. These factors enable the insurer to decide whether or not the property is insurable. If the property is insurable, these factors help place the potential customer into the appropriate risk group. Exemplary factors considered include, but are not limited to, property age, construction, location, loss history, property size, and property management experience.

An insurance company may gather information for use in underwriting a property from several sources. A primary source of information is a completed customer application. The questions on the application are designed to give the insurer much of the information needed to make a decision on insurability. The company may then either reject an application, accept it and offer insurance at a certain rate, or seek additional information in order to determine insurability. In many cases, the company may take into consideration any recommendations made by a broker or insurance agent, particularly if the broker or agent has a good track record with the company. In some cases, an insurer may request an inspection report from an independent company. This inspection report may provide the insurer with a wide range of additional information about a potential property. Additionally, the insurer may seek information about a potential property from one or more of information bureaus supported by the insurance industry. The best known example is the Insurance Services Office (ISO) (Jersey City, N.J.), which maintains centralized files about the claims history of properties that are or were insured by member companies.

The underwriting process is currently a manual process. It can involve numerous people including agents and inspectors, which can be very time-consuming and subject to human error. In view of the foregoing, it can be appreciated that a substantial need exists for systems and methods that can automate the underwriting process, improve decision-making on insurability of a property, reduce the number of people involved, and speed the overall process.

### SUMMARY OF THE INVENTION

The present invention is based on the finding that use of databases containing hail event data and roof damage data provides for a more accurate underwriting process for insuring a property against hail damage. As such, the present invention relate to systems and methods for automating insurance underwriting by integrating information from multiple databases and creating decision making advice useful to insurance underwriters.

In one aspect, the invention provides a system for insurance underwriting of hail risk. The system includes a first data storage device having a hail event database, a roof damage database, and first program instructions, wherein the hail event database comprises data about a plurality of hail events and the roof damage database comprises data about roof types and aging thereof; and a first processor coupled to the first data storage device, the first processor being operable to execute the first program instructions. By executing the first program instructions, the first processor is able to receive a list of property and coverage characteristics about a property, obtain, from the hail event database, a list of hail events within a geographic vicinity of the property, determine a probability that the property will be hit by hail of various sizes based on the list of hail events within the geographic vicinity of the property, obtain, from the roof damage database, the expected damage from hail of various sizes based on the property's roof type and roof age, determine expected insured losses from hail of various sizes based on the list of property and coverage characteristics, and determine an adequate insurance premium for the property.

In various embodiments, the hail event database may include a list of hail storms, the date of each hail storm, duration of each storm, size of hail stones produced by each storm, and geographic area covered by each storm. In various embodiments, the list of property and coverage characteristics about the property comprises one or more of location, construction type, roof type, roof age, number of stories, deductible, and actual cash value endorsement inclusion.

In certain embodiments, the hail event database and the roof damage database are located on separate data storage devices, each being coupled to the processor.

In certain embodiments, the system may further include a second processor coupled to a second data storage device containing second program instructions, the second processor being operable to execute the second program instructions. By executing the second program instructions, the second processor is able to receive the determined insurance premium for the property, and modify the insurance premium based on a first risk score determined by the second processor according to a modification scheme preset externally by an underwriter. In various embodiments, the modification scheme includes a translation table that the second processor uses to translate the first risk score determined by the second processor into a second risk score. In various embodiments, the modification scheme includes a multiplier, and the second processor is operable to multiply the first risk score by the multiplier to produce a second risk score.

In one aspect, the invention provides a method for calculating an adequate hail premium for a property. The method includes a first step of obtaining from a hail event database a list of hail storms in the vicinity around the property. The method includes a second step of obtaining a list of characteristics of the property of interest. The method includes a third step of calculating the annual probability of hail of various sizes hitting the property based on the list of hail storms obtained from the hail event database. The annual probability of hail of various sizes hitting the property is calculated by first calculating the annual probability of hail of various sizes falling in a specified area around the property and then dividing by factor that varies between 1 and 100 and is a non-decreasing function of the number of square miles in the specified area. The method may further include a fourth step of determining the probability of the property's roof incurring damage from hail of various sizes by querying a roof damage database with the property's roof age and roof type. The method may include a fifth step of determining the insured value of the property's roof by first determining the roof square footage by dividing the building area by the number of stories, then querying a roof replacement cost database with the roof square footage, roof type, and property location, then modifying the roof replacement cost by a depreciation schedule if the policy will include an Actual Cash Value endorsement. The method may further include a sixth step of determining the expected insured loss from roof damage for various hail sizes by multiplying the probability of the property's roof incurring damage from hail of various sizes by insured value of the roof and then subtracting the deductible. The method may further include a seventh step of determining the average annual expected insured loss from the roof by multiplying the annual probability of hail of various sizes hitting the property by the expected insured loss for various hail sizes and then adding together the average annual expected insured loss for each hail size. The method may further include an eighth step of determining an adequate premium for the property by multiplying the annual expected insured losses by a factor that covers expenses and required profit margins. The method may further include a ninth step of modifying the adequate premium by a predetermined external factor set by an underwriter.

In all aspects, the method steps described herein may be implemented using a computer processor.

### BRIEF DESCRIPTION OF THE DRAWINGS

FIG. 1 is a schematic diagram showing two paths of communication between a client and a server in an insurance underwriting system containing a client, a database, and a server in accordance with an exemplary embodiment.

FIG. 2 is a schematic diagram showing three paths of communication between a client and a server in an insurance underwriting system containing a client, a database, and a server in accordance with an exemplary embodiment.

FIG. 3 is schematic diagram of a system for insurance underwriting based on hail event histories in accordance with an exemplary embodiment.

FIG. 4 is a schematic diagram of a system for insurance underwriting based on hail event histories including a second processor that modifies the original adequate premium in accordance with an exemplary embodiment.

FIG. 5 is a flowchart showing a first series of steps of a method for calculating an adequate hail premium for a property in accordance with an exemplary embodiment.

### DETAILED DESCRIPTION OF THE INVENTION

The present invention is based on the finding that use of databases containing hail event data and roof damage data provides for a more accurate underwriting process for insuring a property against hail damage.

Before the present systems and methods are described, it is to be understood that this invention is not limited to particular systems, methods, and experimental conditions described, as such methods, and conditions may vary. It is also to be understood that the terminology used herein is for purposes of describing particular embodiments only, and is not intended to be limiting, since the scope of the present invention will be limited only in the appended claims.

As used in this specification and the appended claims, the singular forms “a”, “an”, and “the” include plural references unless the context clearly dictates otherwise. Thus, for example, references to “the method” includes one or more methods, and/or steps of the type described herein which will become apparent to those persons skilled in the art upon reading this disclosure and so forth.

The term “comprising,” which is used interchangeably with “including,” “containing,” or “characterized by,” is inclusive or open-ended language and does not exclude additional, unrecited elements or method steps. The phrase “consisting of” excludes any element, step, or ingredient not specified in the claim. The phrase “consisting essentially of” limits the scope of a claim to the specified materials or steps and those that do not materially affect the basic and novel characteristics of the claimed invention. The present disclosure contemplates embodiments of the invention compositions and methods corresponding to the scope of each of these phrases. Thus, a composition or method comprising recited elements or steps contemplates particular embodiments in which the composition or method consists essentially of or consists of those elements or steps.

Unless defined otherwise, all technical and scientific terms used herein have the same meaning as commonly understood by one of ordinary skill in the art to which this invention belongs. Although any methods and materials similar or equivalent to those described herein can be used in the practice or testing of the invention, the preferred methods and materials are now described.

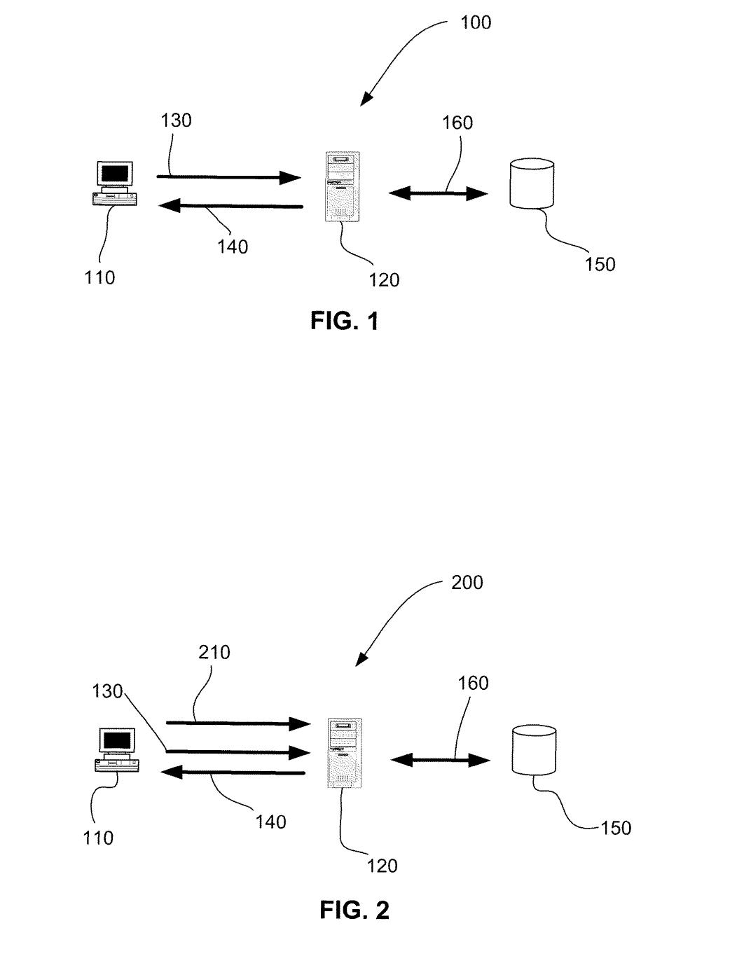

FIG. 1 is a schematic diagram showing two paths of communication between a client and a server in an insurance underwriting system containing a client, a database, and a server. As shown in FIG. 1, underwriting system 100 includes a client 110 that allows information about a property to be entered into system 100. The information may be entered into the system 100 in any of various ways, including, but not limited to an agent or underwriter receiving the information orally from the applicant and entering it into system 100, an agent or underwriter transcribing it from a written application into system 100, and the applicant entering the information directly into the system, where system 100 includes an online user interface.

Thus, the exemplary embodiments described herein can be used with computer hardware and software that perform the methods and processing functions described herein. Exemplary computer hardware include smart phones, tablet computers, notebooks, notepad devices, personal computers, personal digital assistances, and any computing device with a processor and memory area. As will be appreciated by those having ordinary skill in that art, the systems, methods, and procedures described herein can be embodied in a programmable computer, computer executable software, or digital circuitry. The software can be stored on computer readable media. For example, “computer-coded,” “software,” “scripts,” “computer-readable software code,” and “programs” are software codes used interchangeably for the purposes of simplicity in this disclosure. Further, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

Accordingly, the users of client 110 may be an agent, an underwriter, or an applicant. The information is then sent from client 110 to server 120 for processing via communications path 130. Client 110 may also receive an output from the system 100. This output may be in the form of an adequate premium determined by server 120 for the property of interest. The adequate premium determined by server 120 for the property may be sent to client 110 via communications path 140. Thus, client 110 may include a user interface that operates as a presentation tier, or upper tier, by providing a graphical user interface that translates tasks and results into information a user can understand.

While communications paths 130 and 140 are shown as separate lines of communication, it is understood that both communications paths may occur using the same line of connectivity, via any suitable network connection (e.g., Ethernet connection, Digital Subscriber Line (DSL), telephone line, coaxial cable, etc.) so as that the system 100 forms a communications network (e.g., Local Area Network (LAN), Wide Area Network (WAN), Virtual Private Network (VPN), etc.). The communications network is preferably formed by secured network connections so as to protect the system 100 from unauthorized access.

Database 150 operates as the data tier, or lower tier, by utilizing a database computer language (e.g., Structured Query Language (SQL), Extensible Markup Language (XML), etc.) to store and retrieve the data required to provide the functionality of the present invention in a relational database management system (RDBMS). Database 150 may therefore contain information about the property not provided by the applicant. For example, database 150 may include information pertaining to probabilities of hail storms of various severities hitting the property or surrounding area, type and age of roof construction, replacement cost of the building and its components, and any loss history. Database 150 may therefore be used by Server 120 to gather additional information about a property and to verify information already known about a property. Server 120 queries database 150 and receives this information via communications path 160, which may be any suitable communications path, as described above. While client 110, server 120, and database 150 are shown and described as separate machines, it should be understood that in certain embodiments, two or more of these elements may be the same machine.

Server 120 includes the processor of underwriting system 100, and operates as the business logic tier, or middle tier, by coordinating the applications, processing commands, and calculating logical decisions and evaluations that provide the functionality of the present invention. Thus, Server 120 is configured to receive property information entered through client 110, retrieve relevant information from database 150, and calculate the adequate premium of the property. Finally, server 120 may be configured to return the underwriting decision and/or adequate premium of the property to client 110.

In certain embodiments, more than one database 150 may be included in system 100, with server 120 calculating the relevant risk according to information obtained from each database 150. Once a relevant risk is determined, server 120 may then calculate an overall adequate premium for the property. In certain embodiments, the use of one or more databases is under the control of the underwriter or agent in system 100. The underwriter or agent may then explore more than one scenario affecting insurability and/or risk utilizing the one or more databases. Thus, Server 120 may include a suitable programming interface for use in the underwriting process. When system 100 is configured to include an online interface to be accessed by applicants, the use of one or more databases may be preset or varied according the information provided by the applicant. In addition to or as an alternative to those automated processes, a user may also obtain various data from those databases via manual access techniques (e.g., browsing web pages and downloading data, browsing web pages and/or electronic documents and cutting and pasting data, etc.).

The functionality of the system of the present invention is preferably provided using web-based applications. In that way, a user (e.g., broker, account manager, administrator, etc.) can access the functionality of the system via a user interface (e.g., personal computer, laptop computer, personal digital assistant (PDA), smart phone, etc.) using industry standard web browsers (e.g., the CHROME brand web browser from Google, Inc., the FIREFOX brand web browser from the Mozilla Foundation, the INTERNET EXPLORER brand web browser from the Microsoft Corporation, etc.). In certain embodiments, the functionality of the present invention is accessed via a user interface using a secure communication protocol (e.g., Hypertext Transfer Protocol Secure (HTTPS), Internet Protocol Security (IPsec), Datagram Transport Layer Security (DTLS), Secure Socket Tunneling Protocol (SSTP), etc.) so as to protect the database servers from unauthorized access.

FIG. 2 is a schematic diagram showing three paths of communication between a client and a server in an insurance underwriting system containing a client, a database, and a server. As shown in FIG. 2, system 200 is similar to system 100 described above. As such, only the differences will be described herein. System 200 provides a client 110 that allows a modifier to be entered into the system by an underwriter that will modify the adequate premium determined by server 120 prior to being returned to client 110. The modifier is entered via communication path 210. While communications paths 130, 140, and 210 are shown as separate lines of communication, it is understood that all communications paths may occur using the same line of connectivity, via any suitable network connection, as described above. And although a separate processor and database may be shown and/or described with reference to entry of the modifier (below), it should be understood that the modifier may be stored in the database 150 prior to, during, or after the applicant applies for insurance coverage, without departing from the spirit of the invention.

An exemplary modifier is a multiplier that is multiplied by the adequate premium to change the value thereof. Another exemplary modifier is a translation table, which may be used to change the value of adequate premiums within a certain range to a specified value. Modifiers may therefore be used by underwriters to customize the underwriting results according to personal experience and/or specific circumstances related to the property in question. They may also be used to enable the results to match the input parameters of other automated systems. If one or more databases 150 are used, then one or more modifiers may be entered into the system through client 110. Communications paths 130, 140, 160, and 210 provide data communications via one or more computer networks, as described above.

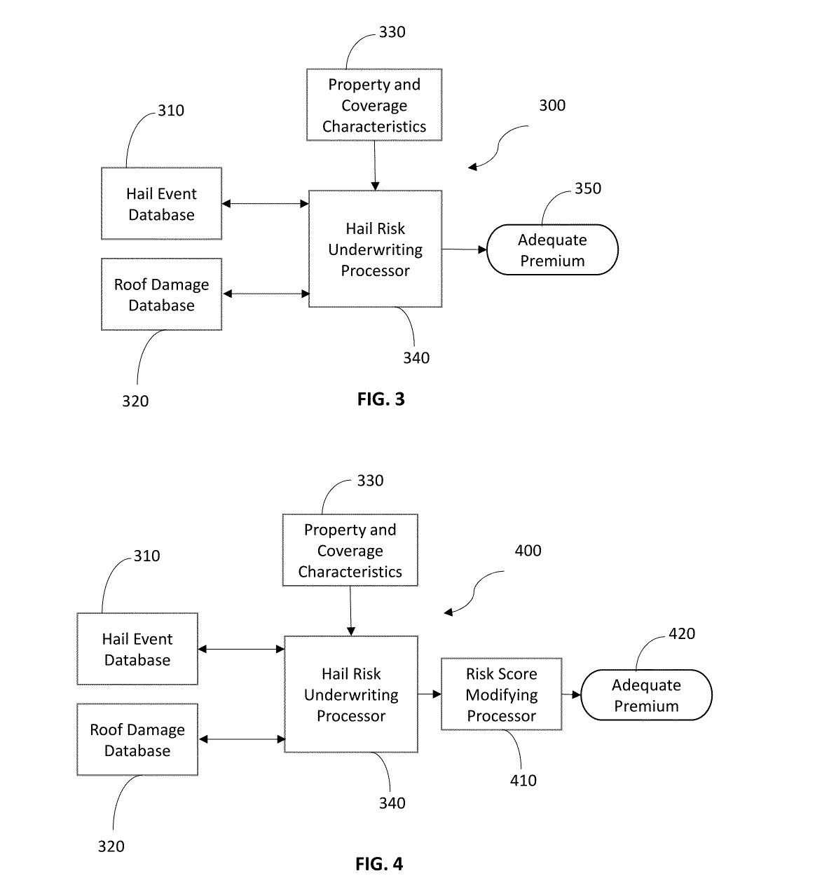

FIG. 3 is schematic diagram of a system for insurance underwriting based on hail event histories. As shown, system 300 includes a hail event database 310, a roof damage database 320, a list of property and coverage characteristics 330, and a hail risk underwriting processor 340. Hail event database 310 contains a list of hail events of a given geographical area including, but not limited to, a date of each storm, duration of each storm, approximate size of hail stones produced by the storm, and geographic area covered by the storm. Roof damage database 320 contains a list of roof types, roof ages, and the probability of damage associated with each combination thereof by various hail stone sizes. The list of property and coverage characteristics 330 contains information about the property obtained from the applicant. This information is obtained during the application process may include, but is not limited to: property location, type of roof construction, age of roof, building square footage, number of stories, deductible, and whether or not the roof will be covered for replacement cost or actual cash value (ACV). Processor 340 retrieves a property's list of nearby hail events and their hail sizes from the hail events database 310. It retrieves the probability of hail damage for each nearby hail event from roof damage database 320. It calculates an adequate premium 350 for the property based on the nearby hail events and associated roof damage probabilities, as described below.

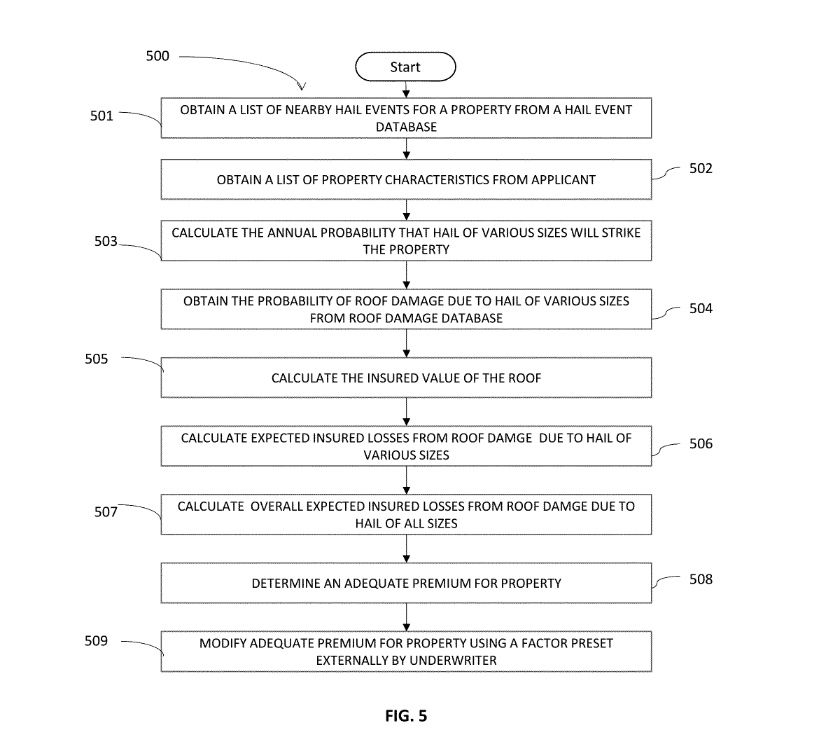

FIG. 4 is schematic diagram of a system for insurance underwriting based on hail events histories. System 400 is similar to system 300, and therefore only the differences will be discussed herein. In system 400, a second processor 410 modifies the adequate premium calculated by the processor 340 using a modifier according to a predetermined modification scheme provided externally by an underwriter. The modification scheme may include a translation table that second processor 410 uses to translate the adequate premium calculated by processor 340 into a risk score. Alternatively or in addition thereto, the modification scheme may include a multiplier that is used by the second processor 410 to produce a calculated risk score 420 by multiplying the adequate premium with the multiplyer.

FIG. 5 is a flowchart showing an exemplary method for calculating an adequate hail premium or hail risk score for a property implemented by the system of the present invention. A series of steps will be described with respect to this method, but those skilled in the art will appreciate that some of these steps may be combined or further broken down into yet additional steps.

In step 501, a list of hail storms that have hit the geographical area near and/or surrounding the property is obtained by the processor from a hail event database. As described above, the hail event database may contain a list of relevant hail storms and information about each hail storm including, but not limited to, a date of the storm, duration of the storm, average size of hail stones produced by the storm, and geographic area covered by the storm. The hail event database may further contain historical hail storms, simulated hail storms, or both.

In step 502, a list of characteristics of the property is obtained by the processor. The list of characteristics of the property and desired coverage parameters are obtained from the applicant. The characteristics may include, but are not limited to, one or more of: property location, type of roof, age of roof, building size/area, number of stories, deductible, and whether or not the roof will be covered for replacement cost or actual cash value (ACV).

In step 503, the annual probability of hail of various sizes hitting the property is calculated by the processor based on the list of hail storms obtained from the hail event database. The annual probability of hail of various sizes hitting the property is calculated by first calculating the annual probability of hail of various sizes falling in a specified area around the property and then dividing by a factor that varies between 1 and 100, and is a non-decreasing function of the number of square miles in the specified area.

In step 504, the probability of the property's roof incurring damage from hail of various sizes is determined by the processor by querying a roof damage database with the property's roof age and roof type.

In step 505, the insured value of the property's roof is determined by the processor by first determining the roof square footage by dividing the building area by the number of stories, then querying a roof replacement cost database with the roof square footage, roof type, and property location, then modifying the roof replacement cost by a depreciation schedule if the policy will include an Actual Cash Value endorsement.

In step 506, the expected insured loss from roof damage for various hail sizes is determined by the processor by multiplying the probability of the property's roof incurring damage from hail of various sizes by the insured value of the roof, and then subtracting the deductible.

In step 507, the average annual expected insured loss from the roof is determined by the processor by multiplying the annual probability of hail of various sizes hitting the property by the expected insured loss for various hail sizes, and then adding together the average annual expected insured loss for each hail size.

In step 508, an adequate premium for the property is determined the processor by multiplying the annual expected insured losses by a factor that covers expenses and required profit margins.

In step 509, the adequate premium may be modified by a predetermined external factor (modifier) set by an underwriter. This modification scheme may be a translation table that translates the adequate premium into a risk score. Alternatively or in addition thereto, this modification scheme may be a multiplier used by the processor to multiply the adequate premium by to produce a risk score.

In various embodiments, method 500 can include one or more additional steps. An exemplary additional step may include modifying the adequate premium or risk score based on previous loss history for the property of interest. This involves multiplying the adequate premium or risk score by a modifier specified in a table containing different modifiers for different frequencies and severities of previous losses. For example, a multiplier of 0.80 may be used for a low frequency, low severity loss history, while a multiplier of 1.40 may be used for a high frequency, high severity loss history.

Another exemplary additional step may include modifying the adequate premium or risk score based on a roof quality assessment for the property. This involves multiplying the adequate premium or risk score by a modifier specified in a table containing different modifiers for different roof qualities. For example, a multiplier of 0.7 may be used for a high quality roof, while a multiplier of 1.50 may be used for a low quality roof.

Although the invention has been described with reference to the above example, it will be understood that modifications and variations are encompassed within the spirit and scope of the invention. Accordingly, the invention is limited only by the following claims.

What is claimed is:

1. A system for insurance underwriting of hail risk, the system comprising:
a first data storage device having a hail event database, a roof damage database, and first program instructions, wherein the hail event database comprises data about a plurality of hail events and the roof damage database comprises data about roof types and aging thereof; and
a first processor coupled to the first data storage device, the first processor being operable to execute the first program instructions to:
receive a list of property and coverage characteristics about a property;
obtain, from the hail event database, a list of hail events within a geographic vicinity of the property,
determine a probability that the property will be hit by hail of various sizes based on the list of hail events within the geographic vicinity of the property, obtain, from the roof damage database, the expected damage from hail of various sizes based on the property's roof type and roof age,
determine expected insured losses from hail of various sizes based on the list of property and coverage characteristics, and
determine an adequate insurance premium for the property.

2. The system of claim 1, wherein the hail event database comprises a list of hail storms, the date of each hail storm, duration of each storm, size of hail stones produced by each storm, and geographic area covered by each storm.

3. The system of claim 1, wherein the list of property and coverage characteristics about the property comprises one or more of location, construction type, roof type, roof age, number of stories, deductible, and actual cash value endorsement inclusion.

4. The system of claim 1, wherein the hail event database and the roof damage database are located on separate data storage devices, each being coupled to the processor.

5. The system of claim 1, wherein the first program instructions are further operable by the first processor to:
modify the insurance premium based on a first risk score determined by the second processor according to a modification scheme preset externally by an underwriter.

6. The system of claim 5, wherein the modification scheme comprises a translation table that the first processor uses to translate the first risk score into a second risk score.

7. The system of claim 5, wherein the modification scheme comprises a multiplier by which the first processor multiplies the first risk score by the multiplier to produce a second risk score.

8. The system of claim 5, wherein the modification scheme comprises a table containing a plurality of modifiers, each associated with one or more of a frequency and severity of previous losses.

9. The system of claim 5, wherein the modification scheme comprises a table containing a plurality of modifiers, each associated with a different roof quality.

10. The system of claim 1, further comprising a second processor coupled to a second data storage device containing second program instructions, the second processor being operable to execute the second program instructions to:
receive the determined insurance premium for the property, and
modify the insurance premium based on a first risk score determined by the first processor according to a modification scheme preset externally by an underwriter.

11. The system of claim 10, wherein the modification scheme comprises a translation table that the second processor uses to translate the first risk score determined by the second processor into a second risk score.

12. The system of claim 10, wherein the modification scheme comprises a multiplier, and the second processor is operable to multiply the first risk score by the multiplier to produce a second risk score.

13. The system of claim 10, wherein the modification scheme comprises a table containing a plurality of modifiers, each associated with one or more of a frequency and severity of previous losses.

14. The system of claim 10, wherein the modification scheme comprises a table containing a plurality of modifiers, each associated with a different roof quality.
